(19) United States
(12) Patent Application Publication
(10) Pub. No.: US 2014/0041244 A1
(43) Pub. Date: Feb. 13, 2014

(54) POSTAL GUIDELINES TOOLS, METHODS OF PRODUCTION AND ASSEMBLY AND USES THEREOF

(71) Applicant: BEN MADRIL, Los Alamitos, CA (US)

(72) Inventor: BEN MADRIL, Los Alamitos, CA (US)

(21) Appl. No.: 13/780,689

(22) Filed: Feb. 28, 2013

Related U.S. Application Data
(60) Provisional application No. 61/604,964, filed on Feb. 29, 2012.

(51) Int. Cl. G01B 3/00

(52) U.S. Cl. CPC G01B 3/002
USPC 33/562

(57) ABSTRACT

A postal compliance tool is described that includes: a first rectangular component, wherein the first component has a height (h1), a length (l1), a width (w1), a top side, a bottom side, and two ends; a second rectangular component, wherein the second component has a height (h2), a length (l2), a width (w2), a top side, a bottom side and two ends; and a substantially flat base that has a length (l3), a width (w3), a height (h3), a top side and a bottom side. A flat one-piece postal compliance pre-tool is also disclosed that includes: at least one depression, at least one sticky or adhesive area, at least one mateable hole and insert coupling, or a combination thereof, wherein the flat one-piece postal compliance tool is formed into the postal compliance tools disclosed herein.

This United States Utility Application claims priority to U.S. Provisional Application Ser. No. 61/604964 filed on Feb. 29, 2012, which is commonly-owned and incorporated herein in its entirety by reference.

### FIELD OF THE SUBJECT MATTER

The field of the subject matter is a postal guidelines tool and a pre-tool, methods of production and assembly and uses thereof.

### BACKGROUND

Regardless of the proliferation of advertising on the internet, companies will still continue to mail leaflets, brochures, ad booklets and other mailings out to homes, businesses and schools. Given the different grades of paper and businesses' desire to do more with advertising for less money, the United States Postal Service and other post offices have had to put out guidelines and regulations that they expect businesses to use to determine whether their mailing can be put into the post office system.

For example, the United States Postal Service (USPS) had to develop a “Droop Test” for larger bulk mail advertising booklets and flyers, because businesses would use thinner paper and the booklets/flyers were not easy for the USPS to automatically sort. The Droop Test is currently outlined in USPS Physical Standards Section 301 for Flat Size Mail. (see USPS DMM 301 Physical Standards for Discount Flats) Flat Size mail is generally more than 11½ inches long, more than 6⅛ inches high, or more than ¼ inch thick. It is also generally not more than 15 inches long, more than 12 inches high, or more than ¾ inches thick, except for “periodicals flats” and “polywrapped flats”. Flat Size mail also has the following general characteristics according to the standards: a) rectangular with four square corners or with finished corners that do not exceed a radius of 0.125 inches, b) characterized as a catalog, and c) fits other size or weight standards that may apply to mail addressed to certain APOs and FPOs, and mail sent by the Department of State to U.S. government personnel abroad.

As part of these standards, there must be a minimum flexibility for Flat-Size pieces or mail, there must be a uniform thickness, and there must be a maximum deflection. The standards indicate that businesses should use a flat surface with an edge (such as a table top or desk) to determine whether a random sampling of their mailings meet these standards. When using a piece of furniture as a testing template, there are no clear delineations of measurement or standards, and the user must keep referring to the Physical Standards guidelines to determine if they are implementing the tests correctly. In addition, the users must keep rulers and weights near the testing surface, in order to transition through all of the tests.

To this end, it would be desirable to develop, produce and utilize a postal compliance tool that a) gives businesses one consolidated tool that allows the business to fully determine if a piece of Flat Size mail meets the standards, b) provides printed information on its surfaces, including mail templates, postal rates, and other postal information, c) is able to be shipped flat and easily assembled by the business, d) is relatively inexpensive so that the business can have several in the locations where they are needed, and e) is portable, so that businesses can move the tool or tools to different areas of the business easily.

### SUMMARY OF THE SUBJECT MATTER

A postal compliance tool is described that includes: a first rectangular component, wherein the first component has a height (h1), a length (l1), a width (w1), a top side, a bottom side, and two ends; a second rectangular component, wherein the second component has a height (h2), a length (l2), a width (w2), a top side, a bottom side and two ends; and a substantially flat base that has a length (l3), a width (w3), a height (h3), a top side and a bottom side.

A flat one-piece postal compliance pre-tool is also disclosed that includes: at least one depression, at least one sticky or adhesive area, at least one mateable hole and insert coupling, or a combination thereof, wherein the flat one-piece postal compliance tool is formed into the postal compliance tools disclosed herein.

### BRIEF DESCRIPTION OF THE FIGURES

FIG. 1 shows a contemplated embodiment of a postal compliance tool.

FIG. 2 shows a contemplated flat one-piece postal compliance pre-tool, wherein the flat one-piece postal compliance tool is formed into the postal compliance tools disclosed herein, such as the one shown in FIG. 1.

FIG. 3 shows a contemplated embodiment of the bottom side of a postal compliance tool.

FIG. 4 shows a contemplated embodiment of a postal compliance tool with an integrated weight component.

FIG. 5 shows a contemplated embodiment of a postal compliance tool with an integrated weight component.

FIG. 6 shows a contemplated postal compliance tool 600 that comprises a difference in length between 13 and 12, and that difference is a base component 620.

FIG. 7 shows a contemplated postal compliance tool 700 that comprises a first rectangular component 710, a second rectangular component 740, and a substantially flat base component 720.

FIG. 8 shows a contemplated postal compliance tool 800 that comprises a first rectangular component 810, a second rectangular component 840, and a substantially flat base component 820.

FIG. 9 shows a contemplated postal compliance tool 900 that comprises a first rectangular component 910, a second rectangular component 940, and a substantially flat base component 920.

A flat one-piece postal compliance pre-tool 1000 is also disclosed and shown in FIG. 10 that includes: at least one depression 1010, at least one sticky or adhesive area 1020, at least one mateable hole 1030 and insert coupling 1040, or a combination thereof, wherein the flat one-piece postal compliance pre-tool 1000 is formed into the postal compliance tools disclosed herein and as shown, for example, in FIG. 1.

A flat one-piece postal compliance pre-tool 1100 is also disclosed and shown in FIG. 11 wherein the various graphics and text 1120 are shown on the tool 1100.

FIG. 12 shows a blow-up/expansion 1140 of the “How to Test Deflection” area 1150 on the flat one-piece postal compliance pre-tool 1100.

FIG. 13 shows a blow-up/expansion 1140 of the “How to Test for Flexibility” area 1160 on the flat one-piece postal compliance pre-tool 1100.

FIG. 14 shows a blow-up/expansion 1140 of one of the measurement areas 1170 on the flat one-piece postal compliance pre-tool 1100.

### DETAILED DESCRIPTION

A postal compliance tool that has now been developed that: a) gives businesses one consolidated tool that allows the business to fully determine if a piece of Flat Size mail meets the standards, b) provides printed information on its surfaces, including mail templates, postal rates, and other postal information, c) is able to be shipped flat and easily assembled by the business, d) is relatively inexpensive so that the business can have several in the locations where they are needed, and e) is portable, so that businesses can move the tool or tools to different areas of the business easily.

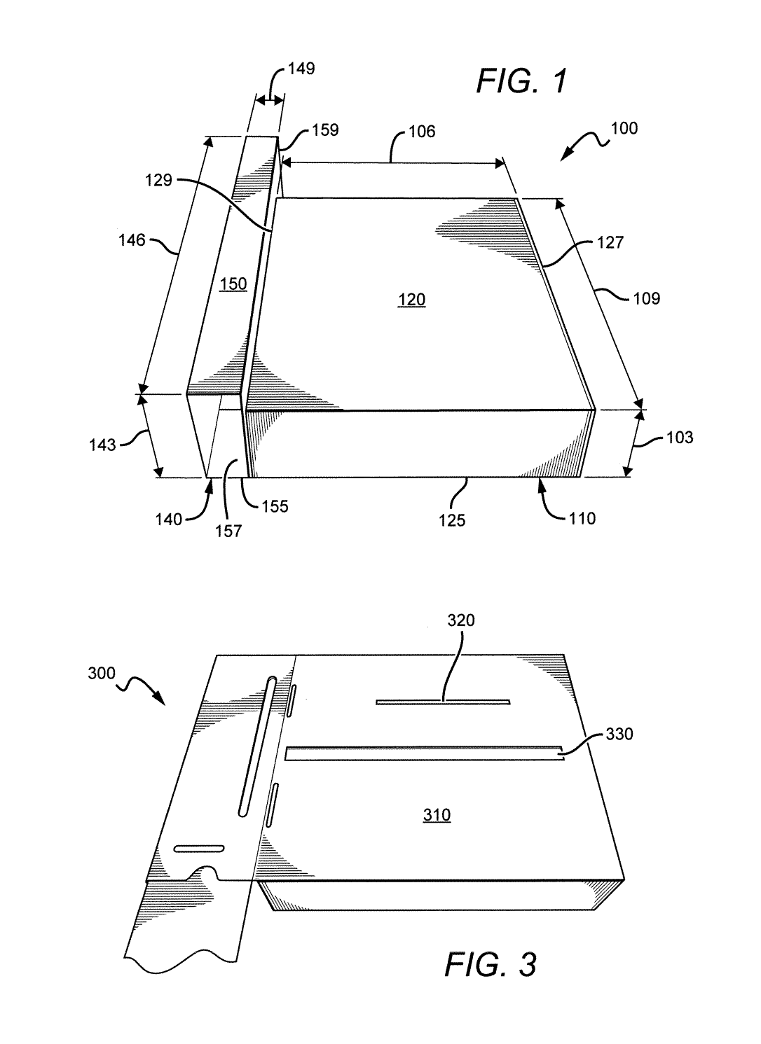

Specifically, a postal compliance tool 100 is described and shown in FIG. 1 that includes: a first rectangular component 110, wherein the first component has a height (h1) 103, a length (l1) 106, a width (w1) 109, a top side 120, a bottom side 125, and two ends 127 and 129; a second rectangular component 140, wherein the second component has a height (h2) 143, a length (l2) 146, a width (w2) 149, a top side 150, a bottom side 155 and two ends 157 and 159; and a substantially flat base (not shown in FIG. 1, but shown in FIG. 3) that has a length (l3), a width (w3), a height (h3), a top side and a bottom side. In some contemplated embodiments, l1 is the same length as l3. In other contemplated embodiments, w3 is the same width as w1+w2.

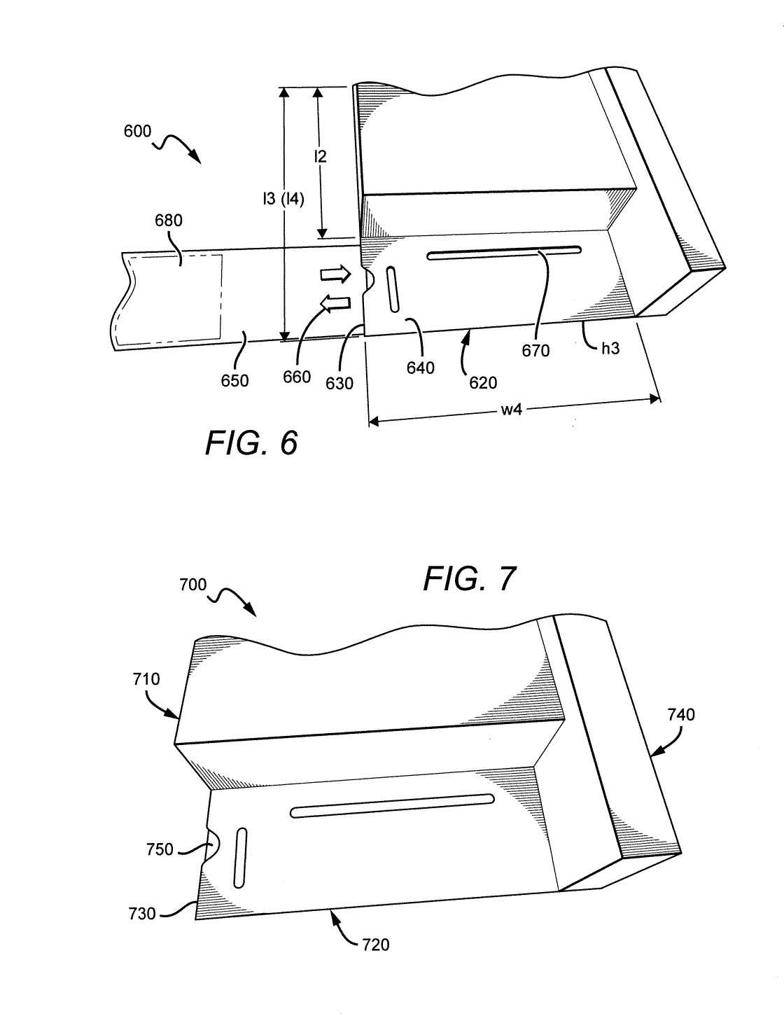

In some embodiments, as shown in FIGS. 6-9, a contemplated postal compliance tool comprises a difference in length between l3 and l2, and that difference is a base component. Contemplated base components comprises a length (l4), a width (w4) and a height (h3), and they also have a top side, a bottom side and a middle section that is between the top side and the bottom side. In some contemplated embodiments the middle section comprises an open space and a placard component is slideably coupled to the middle section. In addition, contemplated base components comprise at least one slit opening. Contemplated base components can be used for any postal compliance reason, but in some embodiments, these base components are used to provide information to the business. For example, if the piece of mail or brochure fails the Droop Test or another current USPS guideline, the placard in the base component can provide information to the customer as to work-arounds, better paper selection, folding information, pricing information and the like. It may be that the business can fold the mailing in half and pass all of the appropriate USPS tests. It could also be that the business could upgrade the paper stock and pass all of the appropriate USPS tests. This placard will help the business determine the best and most cost efficient route;

Each component of contemplated postal compliance tools act to help businesses comply with the Physical Standards section of the USPS DMM. Contemplated postal compliance tools also provide postal information and indicia that provides useful information to the business, while at the same time advertises the printing company, tool manufacturer or other related business.

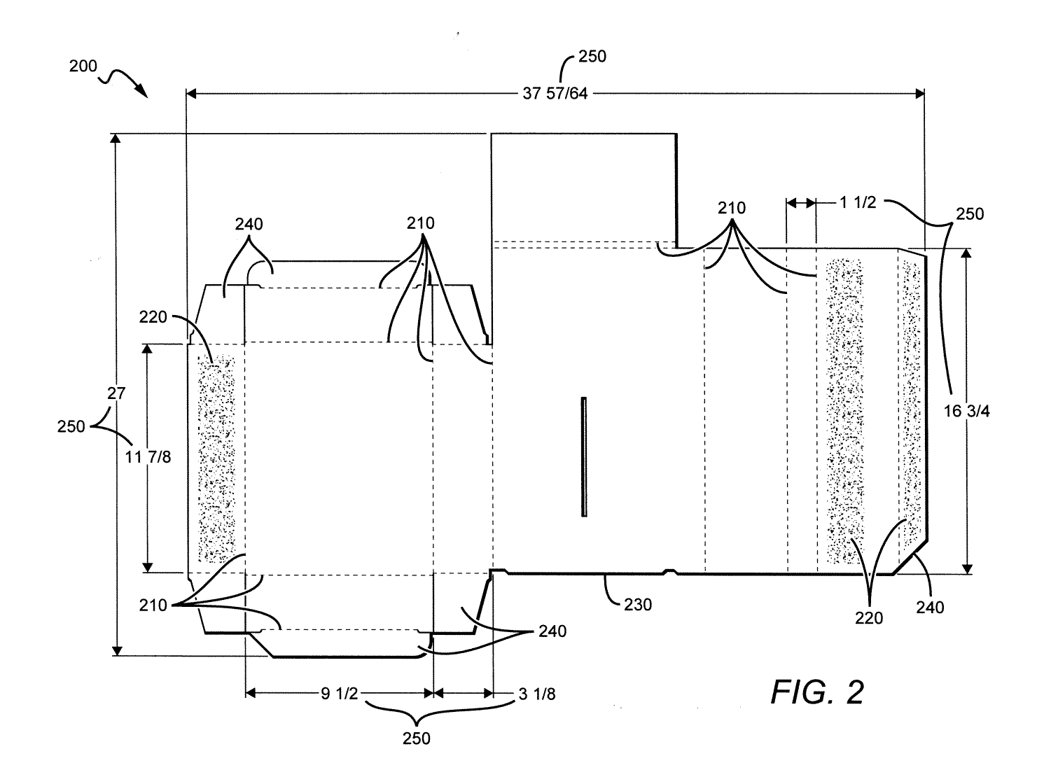

A flat one-piece postal compliance pre-tool 200 is also disclosed and shown in FIG. 2 that includes: at least one depression 210, at least one sticky or adhesive area 220, at least one mateable hole 230 and insert coupling 240, or a combination thereof, wherein the flat one-piece postal compliance pre-tool 200 is formed into the postal compliance tools disclosed herein and as shown, for example, in FIG. 1. The measurements 250 are shown in inches. This pre-tool is a contemplated embodiment where the manufacturer of the pre-tool can easily ship it to businesses to assemble and use as the postal compliance tool. This “assemblability” is one of the key benefits to this postal compliance pre-tool and ultimately—the tool itself.

Contemplated depressions in pre-tools are designed to allow the tool to be folded and assembled into the finished postal compliance tool. Contemplated sticky or adhesive areas on pre-tools are designed to allow parts of the tool to be adhered to other parts of the tool, in order to assemble the final tool. For example, there may be an adhesive area on the side of either the first or second rectangular component that allows the first rectangular component to be adhered to the second rectangular component, in order to secure and stabilize the postal compliance tool. Also, contemplated mateable holes and insert couplings are designed to allow some ends with insert couplings of the pre-tool to be inserted into mateable holes in another area of the pre-tool to finish all or a portion of the postal compliance tool.

FIG. 3 shows a contemplated embodiment 300 of the bottom side 310 of an assembled postal compliance tool that could not be shown in FIG. 1. In this contemplated embodiment, there can be several helpful items for businesses and postal customers, including a mail slit 320 or opening 330 for additional standards determinations, postal indicia or regulations, postal rates and resources, company indicia and branding and other interesting or useful information (shown in a later Figure). So, given that the standard is that mail thickness has to be ¼ of an inch, and definitely less than ¾ of a inch, the slit (or multiple slits) can be provided, along with the rates associated with each thickness standard.

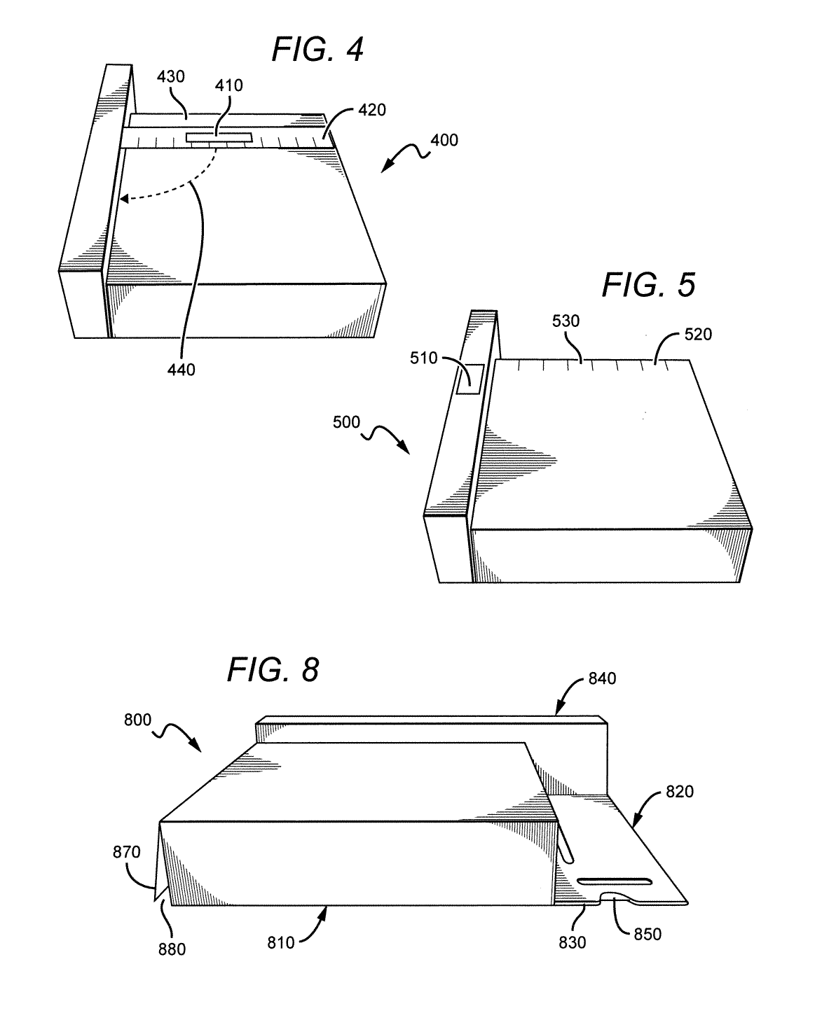

FIG. 4 and FIG. 5 show a contemplated embodiment of a postal compliance tool 400 and 500 with an integrated weight component 410 and 510. Current postal standards indicate that, in the maximum deflection test, Flat-Size mailpieces that are 10 inches or longer must be: a) placed on a flat, straight-edge surface 430 or 530 with the length perpendicular to the edge of the surface and extend the piece 5 inches off the edge of the surface, b) place a flat 12-inch ruler 420 or 520 on top of the mailpiece with the length of the ruler parallel to the edge of the surface as close to the edge as possible, so that a 5-pound weight does not extend past the edge, c) place a certified 5-pound weight on the center of the ruler to hold the piece in place, d) determine the vertical deflection in inches, e) turn the piece around 180 degrees and repeat the process, and f) the piece if mailable as a flat if it does not droop more than 3 inches vertically at either end. Therefore, it would be desirable to provide a ruler component and a weight component. There are several ways to integrate both the ruler component and the weight component into contemplated postal compliance tools, but FIGS. 4 and 5 show two such integration methods. In FIG. 4, the ruler 420 is rotatable 440.

As part of the Droop test, as mentioned above, the mail cannot droop more than 3 inches. Therefore, current contemplated tools are designed to show 3 inches of droop without measurement by the customer. In this regard, the height of the second rectangular component is sized to correspond to the current Droop test standards, which right now is 3 inches. If standards are revised, contemplated postal compliance tools can be easily manufactured to meet these new standards, given how cost efficient they are to manufacture.

FIG. 6 shows a contemplated postal compliance tool 600 that comprises a difference in length between l3 and l2, and that difference is a base component 620. Contemplated base components comprises a length (l4), a width (w4) and a height (h3), and they also have a top side, a bottom side and a middle section 630 that is between the top side 640 and the bottom side (not shown but opposite of top side 640). In some contemplated embodiments the middle section comprises an open space and a placard component 650 comprising text, fees, USPS standards 680 or a combination thereof and is slideably coupled 660 to the middle section. In addition, contemplated base components comprise at least one slit opening 670. Contemplated base components can be used for any postal compliance reason, but in some embodiments, these base components are used to provide information to the business.

FIG. 7 shows a contemplated postal compliance tool 700 that comprises a first rectangular component 710, a second rectangular component 740, and a substantially flat base component 720. This Figure shows the placard component 750 after it has been slideably coupled or inserted into the middle section 730. This embodiment shows how the placard component 750 can be stored.

FIG. 8 shows a contemplated postal compliance tool 800 that comprises a first rectangular component 810, a second rectangular component 840, and a substantially flat base component 820. This Figure shows the placard component 850 after it has been slideably coupled or inserted into the middle section 830. This embodiment shows how the placard component 850 can be stored. One can also view an insert coupling 870 as it is inserted into a mateable opening 880.

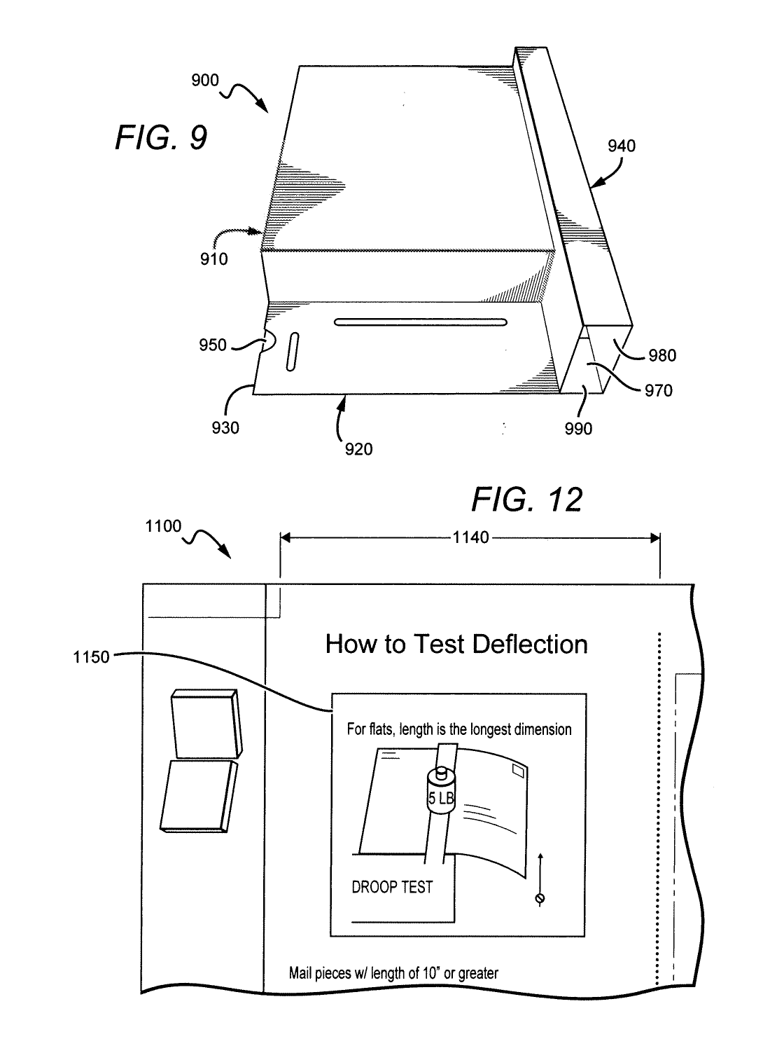

FIG. 9 shows a contemplated postal compliance tool 900 that comprises a first rectangular component 910, a second rectangular component 940, and a substantially flat base component 920. This Figure shows the placard component 950 after it has been slideably coupled or inserted into the middle section 930. This embodiment shows how the placard component 950 can be stored. One can also view an insert coupling 970 as it is inserted into a mateable opening 980 and held in place using a sticky or adhesive area that is not shown, but the result of applying the adhesive is shown by the insert coupling 970 staying in place in area 990.

A flat one-piece postal compliance pre-tool 1000 is also disclosed and shown in FIG. 10 that includes: at least one depression 1010, at least one sticky or adhesive area 1020, at least one mateable hole 1030 and insert coupling 1040, or a combination thereof, wherein the flat one-piece postal compliance pre-tool 1000 is formed into the postal compliance tools disclosed herein and as shown, for example, in FIG. 1. The measurements 1050 are shown in inches. This pre-tool is a contemplated embodiment where the manufacturer of the pre-tool can easily ship it to businesses to assemble and use as the postal compliance tool. This “assemblability” is one of the key benefits to this postal compliance pre-tool and ultimately—the tool itself.

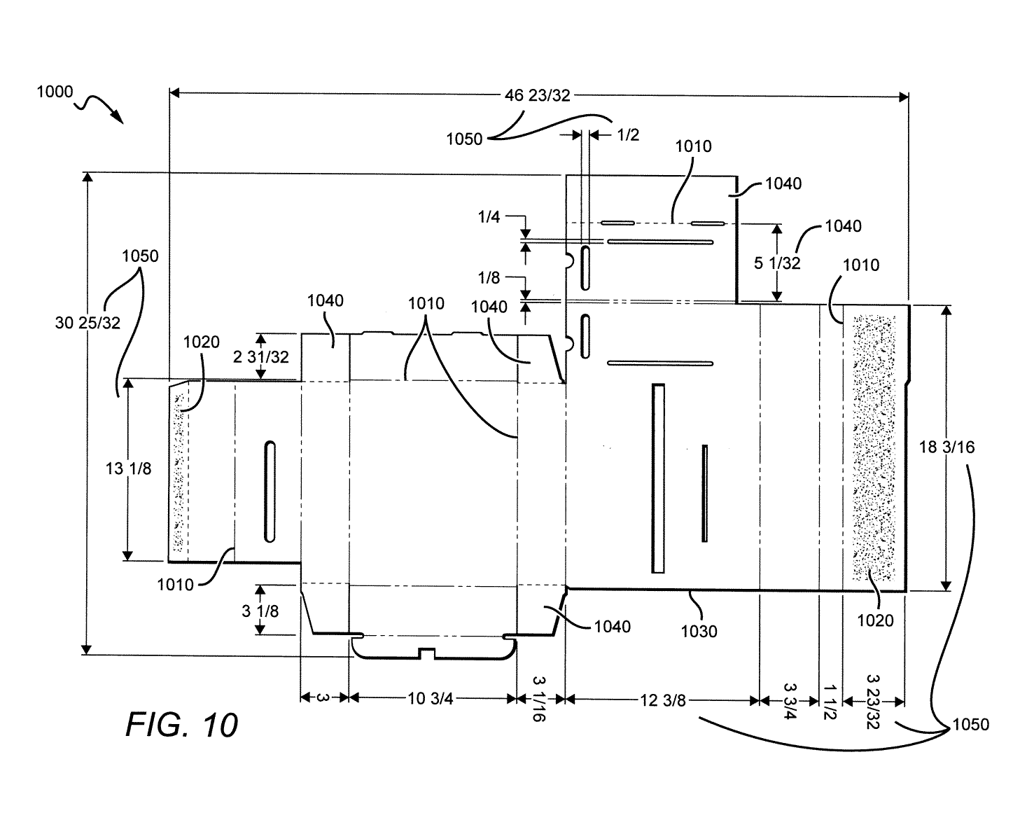

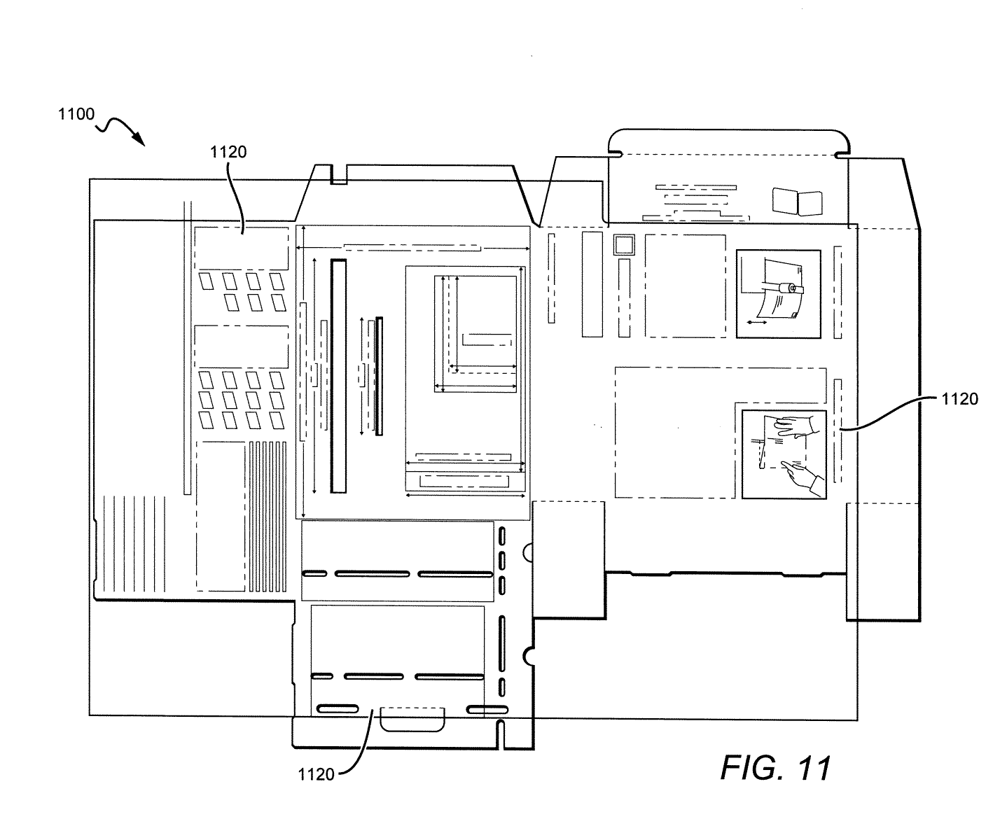

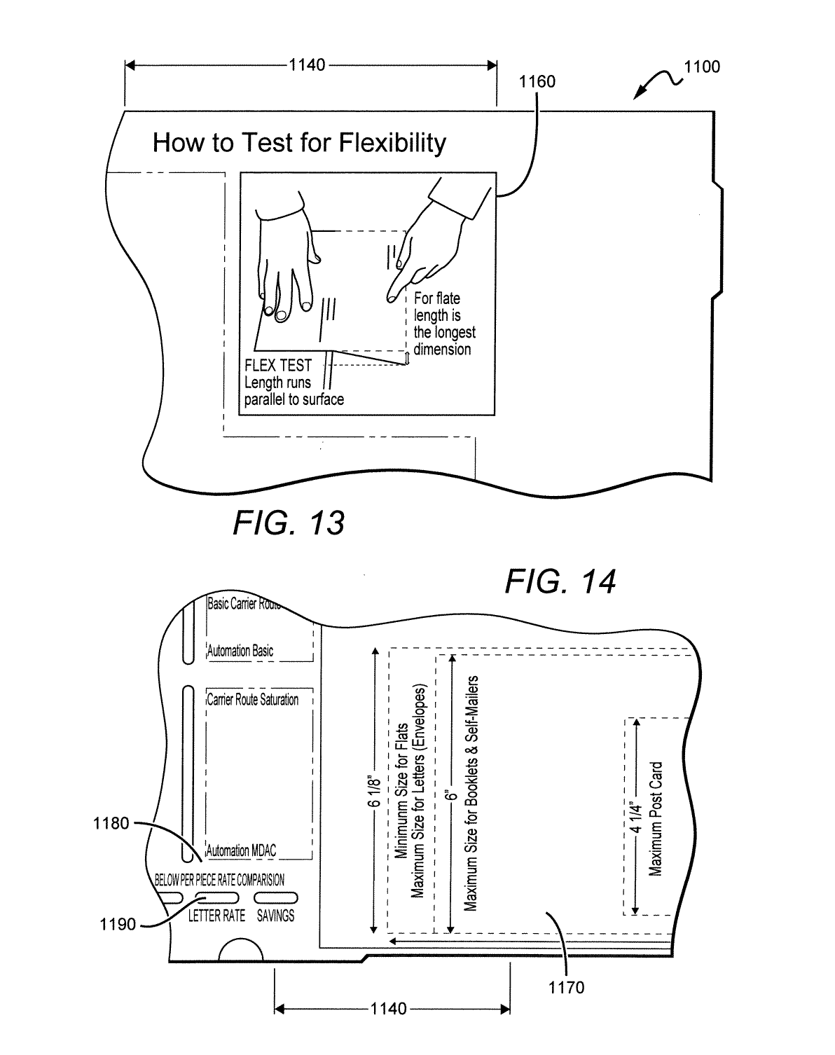

A flat one-piece postal compliance pre-tool 1100 is also disclosed and shown in FIG. 11 wherein the various graphics and text 1120 are shown on the tool 1100. FIG. 12 shows a blow-up/expansion 1140 of the “How to Test Deflection” area 1150 on the flat one-piece postal compliance pre-tool 1100. As it is shown, this area 1140 makes it very clear for the user to determine how to use the final assembled tool (not shown) to test deflection. FIG. 13 shows a blow-up/expansion 1140 of the “How to Test for Flexibility” area 1160 on the flat one-piece postal compliance pre-tool 1100. As it is shown, this area 1140 makes it very clear for the user to determine how to use the final assembled tool (not shown) to test flexibility. FIG. 14 shows a blow-up/expansion 1140 of one of the measurement areas 1170 on the flat one-piece postal compliance pre-tool 1100. As it is shown, this area 1170 makes it very clear for the user to determine how to use the final assembled tool (not shown) to measure pieces of mail for compliance with USPS regulations. You can also see the area 1180 where the slidable placard (not shown) can show rates through slits 1190.

Thus, specific embodiments and methods of a postal guidelines template, methods of production and assembly and uses thereof have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification and claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

I claim:

1. A postal compliance tool, comprising:
a first rectangular component, wherein the first component has a height (h1), a length (l1), a width (w1), a top side, a bottom side, and two ends;
a second rectangular component, wherein the second component has a height (h2), a length (l2), a width (w2), a top side, a bottom side and two ends; and
a substantially flat base that has a length (l3), a width (w3), a height (h3), a top side and a bottom side.

2. The postal compliance tool of claim 1, wherein the first rectangular component is a box.

3. The postal compliance tool of claim 1, wherein the second rectangular component is a box.

4. The postal compliance tool of claim 1, wherein l1 is the same length as l3.

5. The postal compliance tool of claim 1, wherein l2 is less than l3.

6. The postal compliance tool of claim 5, wherein the difference in length between l3 and l2 is a base component.

7. The postal compliance tool of claim 6, wherein the base component comprises a length (l4), a width (w4) and a height (h3).

8. The postal compliance tool of claim 6, wherein the base component has a top side, a bottom side and a middle section that is between the top side and the bottom side.

9. The postal compliance tool of claim 8, wherein the middle section comprises an open space.

10. The postal compliance tool of claim 9, wherein a placard component is slideably coupled to the middle section.

11. The postal component of claim 6, wherein the base component comprises at least one slit opening.

12. The postal compliance tool of claim 1, wherein w3 is the same width as w1+w2.

13. The postal compliance tool of claim 1, further comprising a mail template on the bottom side of the flat base.

14. The postal compliance tool of claim 1, wherein the bottom side of the flat base comprises at least one postal code, at least one postal rate, at least one branding indicia, other suitable indicia, or a combination thereof.

15. The postal compliance tool of claim 13, wherein the mail template comprises an open slit, wherein the slit has a length (l3) and a width (w3).

16. The postal compliance tool of claim 1, wherein the two ends of the first rectangular box are open.

17. The postal compliance tool of claim , wherein the two ends of the second rectangular box are closed.

18. The postal compliance tool of claim 1, wherein the bottom side of the first rectangular component and the bottom side of the second rectangular component form at least a portion of the substantially flat base.

19. A flat one-piece postal compliance pre-tool, comprising:
at least one depression, at least one sticky or adhesive area, at least one mateable hole and insert coupling, or a combination thereof, wherein the flat one-piece postal compliance tool is formed into the postal compliance tool of claim 1.
